(19) United States
(12) Patent Application Publication
(10) Pub. No.: US 2018/0292123 A1
(43) Pub. Date: Oct. 11, 2018

(54) AIR CONDITIONING SYSTEM

(71) Applicant: MAHLE International GmbH, Stuttgart (DE)

(72) Inventors: Bernd BARTENBACH, Talheim (DE); Rainer DIETMEIER, Fellbach (DE); Richard GOCE, Stuttgart (DE)

(73) Assignee: MAHLE International GmbH, Stuttgart (DE)

(21) Appl. No.: 15/924,982

(22) Filed: Mar. 19, 2018

(30) Foreign Application Priority Data
Apr. 10, 2017 (DE) 10 2017 206 116.2

(51) Int. Cl. F25D 21/14; B60H 1/32; B60H 1/00

(52) U.S. Cl. CPC F25D 21/14; B60H 1/00507; B60H 1/3233

(57) ABSTRACT

An air conditioning system having an air conditioner housing and a condensation drain device, the air conditioner housing having a condensation outlet, the condensation drain device being connectable to the condensation outlet, an essentially rotationally symmetrical connecting element having an undercut being provided on the air conditioner housing, and a compatible receiving element being provided on the condensation drain device, so that the condensation drain device may be detachably fastened to the air conditioner housing for transport purposes.

This nonprovisional application claims priority under 35 U.S.C. § 119(a) to German Patent Application No. 10 2017 206 116.2, which was filed in Germany on Apr. 10, 2017, and which is herein incorporated by reference.

### BACKGROUND OF THE INVENTION

### Field of the Invention

The present invention relates to an air-conditioning system, in particular for a motor vehicle.

### Description of the Background Art

Air conditioners in motor vehicles usually comprise an air conditioner housing, in which air ducts, an evaporator and a heating element are accommodated for conditioning the air. A fan conducts air through the air ducts, the air being conducted in a controlled manner through the evaporator and/or the heating element to be able to control the temperature of the air individually. The correspondingly temperature-controlled air is then distributed through different air outlets in the vehicle interior.

The evaporator causes the air flowing therethrough to be cooled, which results in the formation of condensation on the condenser, which must be removed. For this purpose, the air conditioner housing has a condensation outlet, to which a condensation drain device is connected on the outside of the condensation outlet, which guides the condensation guided out of the air conditioner housing out of the motor vehicle. A condensation drain device of this type is designed, for example, as a condensation drain pipe, which is fastened to the air conditioner housing. The connection between the condensation drain pipe and the air conditioner housing takes place with the aid of compression ribs or fastening ribs having an undercut. The condensation drain pipe is connected thereby to the air conditioner housing during the manufacture of the air conditioner housing.

It has been shown that this connection may come loose during transport of the air conditioner housing, and this may result in problems when mounting the air conditioner housing in the vehicle.

Alternatively, it is also known to fasten the condensation drain pipe with the aid of compression ribs or fastening ribs having an undercut for transport, so that the condensation drain pipe may be removed and mounted during the mounting of the air conditioner housing. In the case of this transport attachment, however, it is also generally possible for the condensation drain pipe to fall off during transport and to be missing during mounting. It is also possible for the condensation drain pipe to be fastened too tightly, so that problems or damage may occur during mounting.

Condensation drain pipes have become known, for example, from DE 103 15 381 B4.

### SUMMARY OF THE INVENTION

It is therefore an object of the present invention to provide an air conditioning system, in which the condensation drain device is securely fastened to the air conditioner housing for transport and may nevertheless be easily and safely removed and mounted.

An exemplary embodiment of the invention relates to an air conditioning system, which comprises an air conditioner housing and a condensation drain device, the air conditioner housing having a condensation outlet, the condensation drain device being connectable to the condensation outlet, an essentially rotationally symmetrical connecting element having an undercut being provided on the air conditioner housing, and a compatible receiving element being provided on the condensation drain device, so that the condensation drain device may be detachably fastened to the air conditioner housing for transport purposes.

An exemplary embodiment of the invention relates to an air conditioning system, comprising an air conditioner housing and comprising a condensation drain device, the air conditioner housing having a condensation outlet, the condensation drain device being connectable to the condensation outlet, an essentially rotationally symmetrical connecting element having an undercut being provided on the condensation drain device, and a compatible receiving element being provided on the air conditioner housing, so that the condensation drain device may be detachably fastened to the air conditioner housing for transport purposes.

Due to a design according to the invention, it may be achieved that the condensation drain device is securely connectable to the air conditioner housing, in particular for transport, and may be easily and safely detached again after transport without damage or time delays occurring.

It is also advantageous if the essentially rotationally symmetrical connecting element is a ball head joint element. The attachment and detachment may be safely achieved thereby without difficulties arising during attachment or detachment. The ball head permits easy mounting, connection and detachment because it also permits an inclined mounting or removal, due to its geometry. As a result, the precise active direction of the force for connecting or detaching is not so very important during mounting and detachment, which makes handling easier.

It is also advantageous if the essentially rotationally symmetrical connecting element is designed as a connecting element having an arrow-like or mushroom-like head element having an undercut. A rather uncomplicated connection and detachment may also be achieved thereby.

It is particularly advantageous if the compatible receiving element is essentially a ball socket. An easy and secure interaction with the ball head may be achieved thereby.

In an exemplary embodiment, it is also advantageous if the compatible receiving element is essentially a socket which is designed for the form-fitting reception of an arrow-like or mushroom-like head element having an undercut. An easy and secure interaction with the arrow-like or mushroom-like head element having an undercut may be achieved thereby.

It is also advantageous if the air conditioner housing is made from a first plastic, at least partially or in areas, and the essentially rotationally symmetrical connecting element or the compatible receiving element is injection-molded from the first plastic as a single piece with the air conditioning housing or is injection-molded thereon. An easy manufacture is permitted thereby. A rather complex assembly may be dispensed with.

It is also advantageous if the condensation drain device is made from a second plastic, at least partially or in areas, and the essentially rotationally symmetrical connecting element or the compatible receiving element is injection-molded from the second plastic as a single piece with the condensation drain device or is injection-molded thereon. An easy manufacturing may also be achieved thereby.

It is advantageous if the first plastic is the same as the second plastic or that the first plastic is different than the second plastic. The second plastic may be suitably selected in terms of its elasticity to achieve good connectability and detachability.

In an exemplary embodiment, it is thus advantageous if the first plastic has a higher or a lower elasticity than the second plastic.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a perspective representation of an air conditioner housing and a condensation drain device;

FIG. 2 shows a perspective representation of an air conditioner housing, including a condensation drain device connected thereto;

FIG. 3 shows a schematic view of an arrow-like head element; and

FIG. 4 shows a schematic view of a mushroom-like head element.

### DETAILED DESCRIPTION

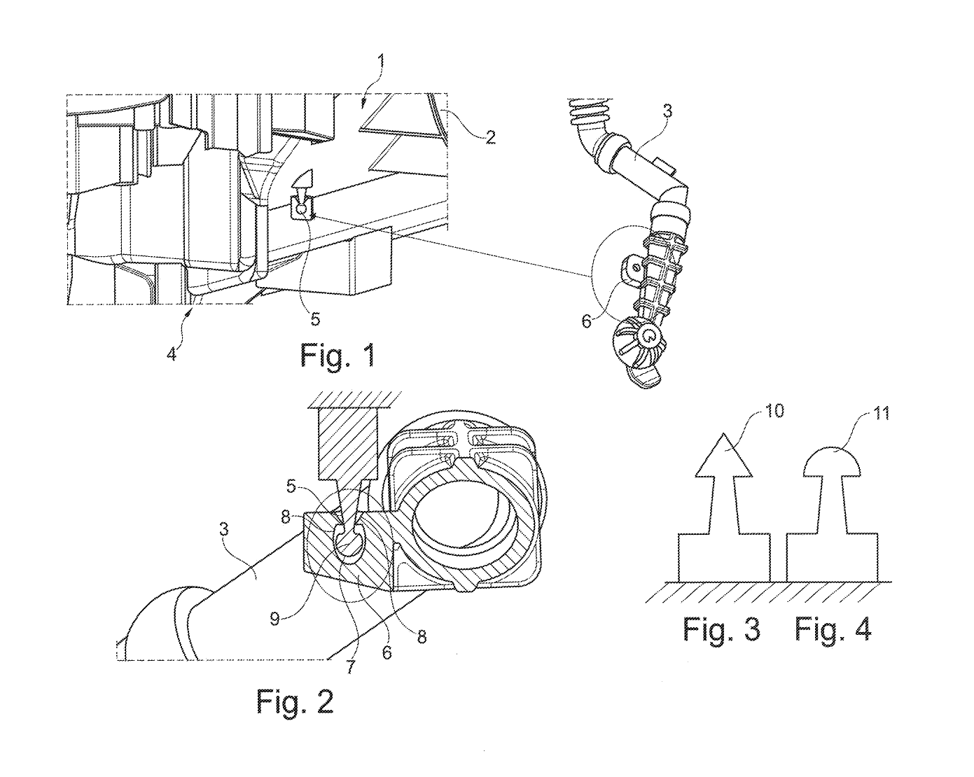

FIG. 1 shows an air conditioning system 1, comprising an air conditioner housing 2 and comprising a condensation drain device 3. Air conditioner housing 2 is manufactured from plastic and has air ducts in its interior, through which air coming from a fan is conducted. The air may flow through an evaporator and/or a heating element for the purpose of being temperature-controlled. In the area below the evaporator, a condensation outlet 4 is provided in air conditioner housing 2, to be able to remove condensation accumulating on the condenser, such as water, from the air conditioner housing.

To safely conduct the condensation out of the vehicle, condensation drain device 3 is designed to be connectable to condensation outlet 4.

However, the condensation drain device is not fixedly connectable to the air conditioner housing, because the latter may run into difficulties during transport and possibly also when mounting the air conditioner or the air conditioner housing in the motor vehicle. The condensation drain device is therefore designed to be connectable to the air conditioner housing. To avoid losing the condensation drain device of the air conditioner housing during transport, the condensation drain device is detachably fastened to the outside of the air conditioner housing, so that it hangs on the air conditioner housing but does not perform any intake function and is thus separate from the condensation outlet. For this purpose, the condensation drain device would have to be connected to the condensation outlet.

To detachably fasten condensation drain device 3 to air conditioner housing 2, an essentially rotationally symmetrical connecting element 5 having an undercut is provided on air conditioner housing 2, and a compatible receiving element 6 is provided on condensation drain device 3, so that condensation drain device 3 may be detachably fastened to air conditioner housing 2, in particular for transport purposes.

FIG. 1 shows air conditioner housing 2 and condensation drain device 3 while they are still separated from each other, and FIG. 2 shows condensation drain device 3 when it is detachably connected to air conditioner housing 2 with the aid of connecting element 5 and receiving element 6.

Alternatively, it may also be provided that an essentially rotationally symmetrical connecting element having an undercut, corresponding to element 5, is provided on condensation drain device 3, and a compatible receiving element, corresponding to element 6, is provided on air conditioner housing 2, so that condensation drain device 3 may be detachably fastened to air conditioner housing 2, in particular for transport purposes.

Connecting element 5 engages with a receptacle 7 of receiving element 6 for connection to receiving element 6. Receptacle 7 has an undercut 8, which is engaged from behind by head element 9 of connecting element 5.

According to FIGS. 1 and 2, essentially rotationally symmetrical connecting element 5 is a ball head joint element. Head element 9 of connecting element 5 is an element designed approximately as a ball. Receiving element 6 compatible therewith is essentially designed as a ball socket.

According to FIG. 3 or 4, essentially rotationally symmetrical connecting element 5 is a connecting element having an essentially arrow-like head element 10 having an undercut or an essentially mushroom-like head element 11 having an undercut. Receiving element 6 compatible therewith is essentially a socket, which is designed for the form-fitting receiving of an arrow-like or mushroom-like head element 10, 11 having an undercut.

According to an embodiment of the invention, it is furthermore advantageous if air conditioner housing 2 is made from a first plastic, at least partially or in areas, and essentially rotationally symmetrical connecting element 5 or compatible receiving element 6 is injection-molded from the first plastic as a single piece with air conditioning housing 2 or is injection-molded thereon. An easy manufacturing is implemented thereby. The first plastic is, for example, a polyamide, polypropylene, etc, optionally including additives.

It is also advantageous if condensation drain device 3 is made from a second plastic, at least partially or in areas, and essentially rotationally symmetrical connecting element 5 or compatible receiving element 6 is injection-molded from the second plastic as a single piece with condensation drain device 3 or is injection-molded thereon. Second plastic may be, for example, the same as the first plastic, or it may be different. For example, the second plastic may be an elastomer.

It is particularly advantageous if the first plastic has a higher or a lower elasticity than the second plastic. This means that the modulus of elasticity of the first plastic is higher or lower than the modulus of elasticity of the second plastic. Higher or lower thus means, for example, at least 10% higher or lower, in particular higher or lower than 50%.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. An air conditioning system comprising:
an air conditioner housing, the air conditioner housing having a condensation outlet; and
a condensation drain device, the condensation drain device being connectable to the condensation outlet;
an essentially rotationally symmetrical connecting element having an undercut provided on the air conditioner housing; and
a compatible receiving element provided on the condensation drain device so that the condensation drain device is adapted to be detachably fastened to the air conditioner housing for transport purposes.

2. An air conditioning system comprising:
an air conditioner housing, the air conditioner housing having a condensation outlet;
a condensation drain device, the condensation drain device being connectable to the condensation outlet;
an essentially rotationally symmetrical connecting element having an undercut provided on the condensation drain device; and
a compatible receiving element provided on the air conditioner housing so that the condensation drain device is adapted to be detachably fastened to the air conditioner housing for transport purposes.

3. The air conditioning system according to claim 1, wherein the essentially rotationally symmetrical connecting element is a ball head joint element.

4. The air conditioning system according to claim 1, wherein the essentially rotationally symmetrical connecting element is a connecting element having an arrow-like or mushroom-like head element having an undercut.

5. The air conditioning system according to claim 3, wherein the compatible receiving element is essentially a ball socket.

6. The air conditioning system according to claim 4, wherein the compatible receiving element is essentially a socket which is designed for the form-fitting receiving of an arrow-like or mushroom-like head element having an undercut.

7. The air conditioning system according to claim 1, wherein the air conditioner housing is made from a first plastic, at least partially or in areas, and the essentially rotationally symmetrical connecting element or the compatible receiving element is injection-molded from the first plastic as a single piece with the air conditioning housing or is injection-molded thereon.

8. The air conditioning system according to claim 1, wherein the condensation drain device is made from a second plastic, and the essentially rotationally symmetrical connecting element or the compatible receiving element is injection-molded from the second plastic as a single piece with the condensation drain device or is injection-molded thereon.

9. The air conditioning system according to claim 7, wherein the first plastic is the same as the second plastic or the first plastic is different than the second plastic.

10. The air conditioning system according to claim 9, wherein the first plastic has a higher or a lower elasticity than the second plastic.
